(19) United States
(12) Patent Application Publication
(10) Pub. No.: US 2023/0065047 A1
(43) Pub. Date: Mar. 2, 2023

(54) MAGNETIC FOOTWEAR

(71) Applicant: Jimmy Wagner, BROOKLYN, NY (US)

(72) Inventor: Jimmy Wagner, BROOKLYN, NY (US)

(21) Appl. No.: 17/840,288

(22) Filed: Jun. 14, 2022

Related U.S. Application Data
(60) Provisional application No. 63/236,365, filed on Aug. 24, 2021.

(51) Int. Cl. A43B 1/00; A43B 3/00; B64G 6/00

(52) U.S. Cl. CPC A43B 1/0054; A43B 3/00; B64G 6/00

(57) ABSTRACT

Electromagnetic boots for walking in a zero-gravity environment such as in outer space, wherein a pathway made from a magnetic material can be provided. Each boot in includes an electromagnet in a sole of the boot and a control unit configured to magnetize and demagnetize the electromagnet. The control unit can synchronize the pair of electromagnetic boots for walking.

### CROSS-REFERENCE TO RELATED APPLICATIONS

This application claims priority from a U.S. Provisional Patent Appl. No. 63/236,365 filed on Aug. 24, 2021, which is incorporated herein by reference in its entirety.

### FIELD OF INVENTION

The present invention relates to magnetic footwear, and more particularly, the present invention relates to magnetic footwear for walking on a metallic path in zero gravity or nearby zero-gravity environments.

### BACKGROUND

Space explorations are now not limited to scientific studies, but enthusiastic people are looking forward to space explorations for recreational purposes. The number of travelers going or willing to go to outer space has been steadily increasing. Besides recreational and scientific purposes, plans to colonize other planets are becoming more popular.

Outer space presents unprecedented challenges, the primary being the atmosphere and gravity. Gravity is essential to hold things to the ground and for people to walk and run. In the zero-gravity environment of outer space, moving from one point to another is difficult and complex. People must learn specific skills to move their bodies in outer space.

A need is therefore appreciated for a device and method that allows people to walk in a zero-gravity environment easily.

The phrase “zero-gravity environment” herein includes a near zero-gravity environment that cannot hold a person to a surface for walking on that surface.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to electromagnetic shoes for waking on a metal path in zero gravity environments.

It is another object of the present invention that a person can easily use electromagnetic shoes without needing any complex training.

It is still another object of the present invention that a person can walk safely in outer space.

It is yet another object of the present invention that the electromagnetic shoes are economical to manufacture.

It is a further object of the present invention that a person can walk easily like walking under gravity.

In one aspect, disclosed is a pair of electromagnetic boots for walking in a zero-gravity environment on a pathway made from a magnetic material, each boot of the pair of electromagnetic boots includes an electromagnet in a sole of the boot; a control unit operably coupled to the electromagnet, the control unit configured to magnetize and demagnetize the electromagnet by supplying energy to the electromagnet, the control unit is further configured to synchronize the pair of electromagnetic boots for walking; and a power source configured to power the control unit and the electromagnets. The power source is a rechargeable battery configured in each boot. The pair of electronic boots further comprises a control panel configured to engage and disengage either of two boots of the pair of electromagnetic boots alternatively or both the boots of the pair of electromagnetic boots. The control unit is configured to ensure at least one of the two boots of the pair is engaged to the pathway. The control unit is configured to control supply of current to the electromagnet for activating and deactivating the electromagnet. Each boot comprises the sole, an upper, and a calf, the calf has an opening for receiving a foot, one or more straps, and a fastener for securing the boot to the foot.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of the electromagnetic boot, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be outlined in order to provide a thorough understanding of the subject innovation. It may be evident, however, that the claimed subject matter may be practiced without these specific details. In other instances, well-known structures and apparatus are shown in block diagram form to facilitate describing the subject innovation. Moreover, the drawings may not be to scale.

Disclosed is an electromagnetic shoe that allows a wearer of the electromagnetic shoe to walk in zero gravity environments. A walkway or pathway made of magnetic metal, such as iron can be provided in spaceships, outside the spaceships, on the surface of planets, moons, and the like outer space bodies. The person wearing the disclosed magnetic shoes can walk on such pathways/walkways/platforms much similar to walking on earth and in a comfortable manner without requiring any special training or skills. People can walk around these iron pathways alone or in groups for day-to-day activities, to enjoy the scenic outside views and the like.

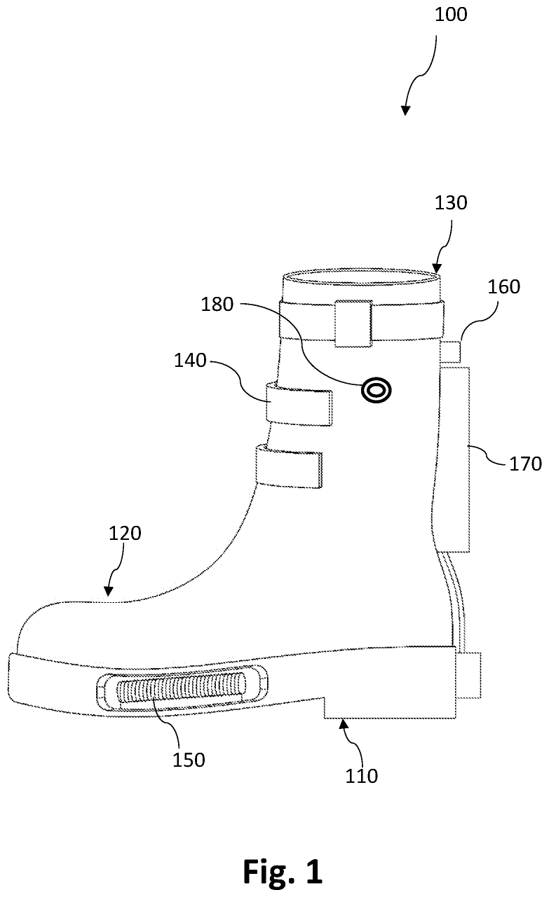

Referring to FIG. 1 shows an exemplary embodiment of the disclosed electromagnetic boots 100. The electromagnetic boots 100 can include a sole 110, an upper 120 to encase the foot, and a calf 130 to cover the ankle and lower leg portion. Straps and fasteners 140 can be provided in the calf 130 to secure the boot to the foot. A foot can be inserted into the opening in the calf and once the foot is comfortably inside the boot, the straps and the fastener can be engaged to secure the electromagnetic boots 100. The electromagnetic boots 100 can be provided in a pair for the left and right feet (FIG. 1 shows a single boot). The term electromagnetic boot(s) is also referred to herein simply as a boot and can refer to a single boot or a pair. The sole 110 of the boots includes an electromagnet 150. The boot can also include a control unit 160 to turn on and off the electromagnet and a battery pack 170. or The battery can be a rechargeable battery or a single-use disposable battery for powering the control unit and the electromagnets. The boot can further include a control panel to receive the inputs from the user to operate the control unit.

In use, the user can first engage the boots, and after use, the boots can be disengaged. When engaged, the electromagnetism is turned on and the boots can be magnetically attached. When disengaged, the electromagnetism is turned off. The boots can be engaged and disengaged using a control panel. For example, a button 180 can be provided on one of the pairs of boots, wherein the user can bend and press the button. The control panel can also be provided as a handheld device wherein the control panel can be connected to the control unit in the boots using a wired or wireless connection.

When engaged, the control unit can synchronize the pair of boots either manually or automatically. In one implementation of automatic synchronization, the control unit can ensure that only one boot of the pair can engage or couple to the pathway and in an alternate manner, and at least one boot is always magnetically attached to the pathway. When a user steps and places the foot on the pathway, the boot magnetically attaches to the pathway while the other boot is automatically released so that the user can take the next step. Thus, the user can easily and comfortably walk. The user can override this process and can instruct the control unit to allow both the boots of the pair to be magnetically attached to the pathway as and when desired. Since one boot of the pair always remains magnetically attached to the pathway, any risk of the user getting lost can be avoided. It is understood that control units in both the boots can be common or connected through a wired or wireless connection.

In another implementation, the boots can be physically synchronized by the wearer. The terms “wearer” and “user” are interchangeably used herein and refer to a person who wears or is wearing or wishes to wear the disclosed electromagnetic boots. Also, the terms shoes, footwear, and boots are interchangeably used herein.

The control panel can also be provided in the hand of the user to control and synchronize the two boots for walking. The control panel can be operated by a single hand, both hands, or two separate control panels can be provided for two hands. The control panels can have buttons to receive input from the user. Alternatively, the input can be provided as certain hand gestures that can be detected by the control panel.

In another implementation, the manual synchronization can be affected by the foot itself. Certain gestures, such as tapping the toe twice, putting pressure on the toe or feet, and the like can be used to magnetize and demagnetize the boots alternatively. The control unit can ensure that at least one of the boots remains magnetized and attached to the pathway.

The boots can be powered by a suitable battery, such as a lithium battery that can power the electromagnets and the control unit. The battery can be removable and replaceable. Either rechargeable or disposable batteries can be used without departing from the scope of the present invention. In case, a rechargeable battery is used, suitable charging circuitry can also be provided. In certain embodiments, the power can also be provided by the pathway to the shoes while walking on the pathway. Suitable capacitors can be provided to temporarily store the power received from the pathway when the boot touches the pathway. Wireless charge transfer from the pathway to the boots is also within the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A pair of electromagnetic boots for walking in a zero-gravity environment on a pathway made from a magnetic material, each boot of the pair of electromagnetic boots comprises:
an electromagnet in a sole of the boot;
a control unit operably coupled to the electromagnet, the control unit configured to magnetize and demagnetize the electromagnet by supplying energy to the electromagnet, the control unit is further configured to synchronize the pair of electromagnetic boots for walking; and
a power source configured to power the control unit and the electromagnets.

2. The pair of electronic boots according to claim 1, wherein the power source is a rechargeable battery configured in each boot.

3. The pair of electromagnetic boots according to claim 1, wherein the pair of electronic boots further comprises a control panel configured to engage and disengage either of two boots of the pair of electromagnetic boots alternatively or both the boots of the pair of electromagnetic boots.

4. The pair of electromagnetic boots according to claim 1, wherein the control unit is configured to ensure at least one of the two boots of the pair is engaged to the pathway.

5. The pair of electromagnetic boots according to claim 1, wherein the control unit is configured to control supply of current to the electromagnet for activating and deactivating the electromagnet.

6. The pair of electromagnetic boots according to claim 1, wherein each boot comprises the sole, an upper, and a calf, the calf has an opening for receiving a foot, one or more straps, and a fastener for securing the boot to the foot.
